(19) United States
(12) Patent Application Publication
(10) Pub. No.: US 2026/0072418 A1
(43) Pub. Date: Mar. 12, 2026

(54) LASER PROCESSING DEVICE, METHOD, COMPUTER PROGRAM PRODUCT AND WORKPIECE

(71) Applicant: 4JET MICROTECH GMBH, Alsdorf (DE)

(72) Inventors: Tobias DYCK, Aachen (DE); Alexander ECKHARDT, Grevenbroich (DE); Oliver ALBRICH, Aachen (DE); Marc HÜSKE, Hannover (DE)

(21) Appl. No.: 19/106,575

(22) PCT Filed: Aug. 26, 2022
(86) PCT No.: PCT/EP2022/073826

§ 371 Date: Feb. 25, 2025

(51) Int. Cl. G05B 19/18

(52) U.S. Cl. CPC G05B 19/182; G05B 2219/45165

(57) ABSTRACT

There is disclosed a laser processing device and a method for processing a workpiece (105) that is provided with a first pattern (104), the method comprising: sensing the first pattern (104) and providing hereupon sensor data (154) from which a representative pattern (110) is determinable that represents at least a part of the first pattern (104) of the workpiece (105); determining a mapping rule (108) that defines a mapping from an ideal first pattern to the representative pattern (110), wherein the ideal first pattern is associated with the first pattern (104) of the workpiece (105); applying the mapping rule (108) to an ideal second pattern (123) to thereby generate processing data (124) that represents a second pattern (134) to be generated; processing the workpiece (105) according to the processing data (124).

### CROSS-REFERENCE TO RELATED APPLICATIONS

This application is a National Phase Patent Application and claims priority to and the benefit of International Application Number PCT/EP2022/073826, filed on Aug. 26, 2022, the entire contents of which is incorporated herein by reference.

### TECHNICAL FIELD

The present disclosure relates to the field of processing workpieces with laser radiation.

### BACKGROUND

It is known from practice to perform processing of workpieces relative to markings that are already present on the workpiece.

### SUMMARY

In view of the above described situation, there may be a need for a technique that allows precise processing of a workpiece.

This need is met by the independent claims. Some advantageous embodiments are set forth in the dependent claims.

According to a first aspect of the herein disclosed subject matter, a laser processing device is provided.

According to an embodiment of the first aspect, there is provided a laser processing device for processing a workpiece that is provided with a first pattern, the laser processing device comprising: a sensor device; a control device; and a laser device; wherein the sensor device is configured for sensing a first pattern and for providing hereupon sensor data from which a representative pattern is determinable that represents at least a part of the first pattern of the workpiece; wherein an ideal first pattern is associated with the first pattern of the workpiece; wherein the control device is configured to determine a mapping rule that defines a mapping from the ideal first pattern to the representative pattern; wherein the control device is configured to apply the mapping rule to an ideal second pattern to thereby generate processing data that represents a second pattern to be generated; wherein the control device is configured to control the laser device and thereby process the workpiece according to the processing data.

According to a second aspect of the herein disclosed subject matter, there is provided a method.

According to an embodiment of the second aspect, there is provided a method for processing a workpiece that is provided with a first pattern, the method comprising: sensing a first pattern and providing hereupon sensor data from which a representative pattern is determinable that represents at least a part of the first pattern of the workpiece; determining a mapping rule that defines a mapping from an ideal first pattern to the representative pattern, wherein an ideal first pattern is associated with the first pattern of the workpiece; applying the mapping rule to an ideal second pattern to thereby generate processing data that represents a second pattern to be generated; processing the workpiece according to the processing data.

According to a third aspect of the herein disclosed subject matter, there is provided a computer program product.

According to an embodiment of the third aspect, there is provided a computer program product that is configured to, when executed on a processor device, control a method according to at least one embodiment of the second aspect.

According to a fourth aspect of the herein disclosed subject matter, there is provided a workpiece.

According to an embodiment of the fourth aspect, there is provided a workpiece, the workpiece comprising a first pattern that is, compared to an ideal first pattern, transformed according to a mapping rule; and a second pattern that is, compared to an ideal second pattern, transformed according to the mapping rule.

Although certain disadvantages of prior technologies are mentioned herein, the claimed subject matter is not intended to be limited to implementations that eliminate some or all of the mentioned disadvantages of the prior technologies. Furthermore, although certain advantages of the herein disclosed subject matter are mentioned or implied in the present disclosure, the claimed subject matter is not intended to be limited to implementations that comprise some or all of these advantages.

### DESCRIPTION OF EXEMPLARY EMBODIMENTS

According to an embodiment, a laser processing device according to the first aspect is configured for processing a workpiece that is provided with a first pattern, i.e. for processing a workpiece that already comprises the first pattern.

According to an embodiment, the laser processing device comprises a sensor device, a control device and a laser device. According to a further embodiment, the sensor device is configured for sensing the first pattern and for providing hereupon sensor data from which a representative pattern is determinable, wherein the representative pattern represents at least a part of the first pattern of the workpiece.

According to an embodiment, an ideal first pattern is associated with the first pattern of the workpiece. For example, a first pattern definition is associated with the first pattern, wherein the first pattern definition defines the ideal first pattern.

According to an embodiment, the control device is configured for determining a mapping rule that defines a mapping of the ideal first pattern to the representative pattern.

According to a further embodiment, the control device is configured to apply the mapping rule to an ideal second pattern to thereby generate processing data that represents a second pattern to be generated. According to an embodiment, the control device is configured for controlling the laser device and thereby processing the workpiece according to the processing data.

According to an embodiment, a method according to the second aspect is configured for processing a workpiece that is provided with a first pattern. According to an embodiment, the method comprises sensing the first pattern and providing sensor data from which a representative pattern is determinable. According to an embodiment, the representative pattern represents at least a part of the first pattern of the workpiece.

According to an embodiment, the method comprises determining a mapping rule that defines a mapping from an ideal first pattern to the representative pattern, wherein the ideal first pattern is associated with the first pattern. For example, according to an embodiment, a first pattern definition is associated with the first pattern of the workpiece and the first pattern definition defines the ideal first pattern.

According to an embodiment, the first pattern corresponds to the ideal first pattern except for deviations. The deviations may be caused, for example, by the manufacturing process (for example manufacturing tolerances) or by a change in environmental conditions. For example, during a processing operation, temperature fluctuations may occur within the workpiece that lead to a distortion of the first pattern with respect to the ideal first pattern due to the thermal expansion. The deviations may be temporary or permanent.

According to an embodiment, the method comprises applying the mapping rule to an ideal second pattern to thereby generate processing data that represents a second pattern to be generated. According to a further embodiment, the method comprises processing the workpiece according to the processing data.

According to an embodiment, a computer program product according to the third aspect is configured to control a method described herein. In particular, according to an embodiment, the computer program product is configured to control at least one of a sensor device, a control device and a laser device according to at least one embodiment.

According to an embodiment, a workpiece according to the fourth aspect comprises a first pattern and a second pattern, wherein the first pattern is, compared to an ideal first pattern, transformed according to a mapping rule and the second pattern is, compared to an ideal second pattern, transformed according to the same mapping rule. According to an embodiment, the first pattern and the second pattern were generated in different process steps.

In the context of the present disclosure, the term “pattern” (for example, for a first pattern disclosed herein or a second pattern disclosed herein) is not limiting and may be any feature of the workpiece. A suitable translation for the German term “Muster” would be, for example, the English term “pattern”. For example, a pattern may be a sensable (i.e. detectable) feature of the workpiece, for example a feature which is optically or tactilely sensable. Furthermore, according to an embodiment, a pattern may be an arrangement of at least two features, for example a regular arrangement or an irregular arrangement. According to an embodiment, the first pattern is a first pattern originating from the production of the workpiece. According to a further embodiment, the workpiece was provided with the first pattern in a previous process step.

According to an embodiment, the ideal first pattern is a desired pattern, i.e. a pattern that should be present on the workpiece, wherein the first pattern actually present on the workpiece normally deviates from the ideal first pattern, for example due to manufacturing tolerances during the manufacture of the first pattern or for example due to deformation of the workpiece after the production of the first pattern.

According to an embodiment, the sensor device is a device which is configured for sensing the first pattern and for providing hereupon the sensor data. According to an embodiment, the representative pattern is identical to the first pattern.

According to an embodiment, the laser device is configured for processing the workpiece. For example, according to an embodiment, the laser device is configured for directing a laser beam to the workpiece and thereby processing the workpiece.

According to an embodiment, it was intended to provide a workpiece with the ideal first pattern and the ideal second pattern, wherein the ideal first pattern and the ideal second pattern have a predetermined spatial relationship to each other (for example have a predetermined distance to each other or have a predetermined orientation relative to each other). For example, according to an embodiment at least a part of the pattern elements of the ideal second pattern is at the same position as corresponding pattern elements of the ideal first pattern. For example, according to an embodiment, the ideal first pattern and the ideal second pattern is a point pattern, wherein with each point of the ideal first pattern a point of the ideal second pattern is associated, which is located at the same position as the point of the ideal first pattern, but according to an embodiment has a smaller radius than the point of the ideal first pattern.

In practice, providing a workpiece with a pattern may always be performed only within certain manufacturing tolerances. Furthermore, a pattern of a workpiece may be changed after the production by deformation of the workpiece. A deformation of the workpiece may occur for example due to different temperatures during the production of the first pattern and the production of the second pattern. By generating the second pattern (on the workpiece) according to embodiments of the herein disclosed subject matter, the second pattern may be generated with an accuracy of a few micrometers relative to the first pattern. For example, in the case of two superimposed point patterns, each point of the second pattern may be generated with an accuracy of a few micrometers in a point of the first pattern.

At least some of the aspects and embodiments of the herein disclosed subject matter are based on the idea that providing the workpiece with the first pattern and the second pattern may be optimized in that, before providing the workpiece with the second pattern, the first pattern actually present on the workpiece is sensed, a deviation from the desired ideal first pattern is determined, and subsequently the deviation is taken into account in the generation of the second pattern. In this way, a spatial relationship between the ideal first pattern and the ideal second pattern (for example a coincidence) may be realized with high accuracy on the workpiece, even if the generation of the first pattern and the second pattern are performed on the workpiece in different process steps (for example with different laser devices). According to an embodiment, “congruent” means congruent only in the positions of the pattern elements of first and second pattern, but does not exclude a different shape and/or size of the pattern elements of the second pattern compared to the shape and/or size of the pattern elements of the first pattern.

According to an embodiment, the control device is configured for taking into account at least one of the following in the determination of the mapping rule: (i) a linear displacement between the first pattern and the ideal first pattern; (ii) a distortion of the first pattern with respect to the ideal first pattern; (iii) a rotation of the first pattern with respect to the ideal first pattern.

In particular, by taking into account distortion and/or rotation of the first pattern with respect to the ideal first pattern, a deviation between the first pattern and the ideal first pattern due to temperature gradients within the workpiece may be taken into account.

According to an embodiment, the distortion of the first pattern with respect to the ideal first pattern comprises at least one of the following: (i) a stretching or compression of the first pattern with respect to the ideal first pattern in at least one direction; (ii) a shearing of the first pattern with respect to the ideal first pattern. According to a further embodiment, the stretching or compression is present in two directions. The stretching or compression in the two directions may be different. It is understood that the two directions are linearly independent of each other. For example, the two directions may be perpendicular to each other according to an embodiment.

Thus, the mapping rule according to an embodiment provides a mapping of an extended portion of the ideal first pattern to an extended section of the representative pattern. The term “extended” is to be understood in this embodiment as a delimitation to a merely punctiform mapping. In other words, according to an embodiment, not only the coordinates of a single point (for example (X1, Y1)) are mapped (for example to the coordinates (X1*, Y1*)) by the mapping rule, but, according to an embodiment, the mapping of a point set of at least two points (for example four points ((X1, Y1), (X2, Y2), (X3, Y3), (X4, Y4)) of the ideal first pattern to a corresponding point set of the representative pattern ((X1*, Y1*), (X2*, Y2*), (X3*, Y3*), (X4*, Y4*)) is carried out. Here, the point set is also referred to as a container. For example, two points are sufficient for taking into account a displacement and/or taking into account a rotation of the first pattern with respect to the ideal first pattern. In other words, according to an embodiment, the mapping rule can map a point set which consists of two points. According to a further embodiment, the point set can consist of three points or of four points.

According to an embodiment, the points of a container are defined exclusively by spatial coordinates (for example Cartesian coordinates X, Y in a plane, as explained by way of example above). Here, the spatial coordinates can define (only) one point of the relevant first pattern or representing pattern. According to a further embodiment, the point defined by the spatial coordinates is representative of a pattern element of the respective pattern (for example of the first pattern, of the ideal first pattern or of the representing pattern). In other words, according to an embodiment, associated with a pattern element is a point which represents the pattern element and which is a part of the representing pattern. For example, according to an embodiment, the point defined by the spatial coordinates is the center of gravity of a pattern element of the respective pattern. According to an embodiment, associated with each pattern element of the first pattern that defines the representing pattern is a point which represents the pattern element and which is a part of the representing pattern.

According to an embodiment, the first pattern comprises a plurality of pattern elements. Correspondingly, according to an embodiment, also the ideal first pattern comprises a plurality of pattern elements. For example, the pattern elements may be holes in a layer of the workpiece. According to an embodiment, the pattern elements are circular. According to a further embodiment, the pattern elements are linear. In general, the pattern elements may have a simple geometric shape or else a complex geometric shape. According to an embodiment, pattern elements may be individual pattern elements separated from each other. According to another embodiment, two or more pattern elements may be contiguous. In general, pattern elements as described herein may be referred to as predetermined portions. In this respect, the terms “pattern element” and “portion” (or the terms “pattern element” and “pattern portion”) are used synonymously herein.

According to an embodiment, the points of a container are defined by spatial coordinates and further coordinates. In other words, in this embodiment, spatial coordinates and further coordinates are associated with each point (which represents a pattern element). For example, the spatial coordinates can define a center of gravity of a pattern element and the further coordinates can define, for example, an orientation of the pattern element. Such an embodiment may be applicable, for example, if the pattern elements are not rotationally symmetrical.

If a pattern element is circular, in accordance with an embodiment, two coordinates X, Y in a plane suffice for defining a position of the pattern element—at least if a radius of the circular pattern element is not important. If the radius of a circular pattern element is important, the radius can be, for example, a further coordinate of the pattern element (in the above sense). In general, a further coordinate can also be referred to as a “parameter”.

The spatial coordinates can be Cartesian coordinates, as explained by way of example above, i.e. in an embodiment the spatial coordinates are defined in a Cartesian coordinate system. According to a further embodiment, the spatial coordinates can be defined in any other suitable coordinate system, for example in a polar coordinate system.

By defining the mapping rule for a point set (in contrast to a merely punctiform mapping for a single point), the mapping rule can also describe a distortion of the representative pattern.

According to an embodiment, the representative pattern corresponds to a part of the first pattern (for example, according to an embodiment, the representative pattern comprises only a part of the pattern elements of the first pattern).

According to an embodiment, the sensor device is configured for sensing the first pattern on the workpiece and for providing hereupon corresponding sensor data that represent the first pattern on the workpiece. For example, it may be provided that the workpiece is sensed by the sensor device in two spatial directions (for example an X-direction and a Y-direction). For example, the sensor device may comprise an image sensor and the sensor data may be image data.

According to an embodiment, the representative pattern is determined from the sensor data. According to an embodiment, the representative pattern corresponds to a container as described herein. For example, according to an embodiment, in predetermined raster steps a point set which consists of at least two points and which forms the representative pattern is determined from the sensor data. According to an embodiment, the points of the point set are those points which have a maximum distance from each other within the raster step. In other words, according to an embodiment, the points of the point set are those points which are adjacent from a start point of a raster step and an end point of a raster step. According to an embodiment, the rasterization is performed in two linearly independent directions, whereby two-dimensional raster fields are defined. According to an embodiment, the points of the point set (e.g. the points of the representative pattern) are those points within the raster field which are adjacent to the corners of the raster field (i.e. those points which have a minimum distance from the corners of the raster field). The determination of the representative pattern in a two-dimensional raster field allows the detection of a distortion or a rotation of the first pattern with respect to the ideal first pattern.

For example, it may be provided that elements (e.g. points) of the representative pattern are determined from the sensor data in two spatial directions (for example an X-direction and a Y-direction) in each raster field. According to an embodiment, the rasterization provides at least one raster field (depending on the size of the first pattern and the size of the raster field), for example a single raster field or a plurality of raster fields. According to an embodiment, the at least one raster field has a predetermined size, for example 100 millimeters×100 millimeters (100 mm×100 mm). The size of the raster field is also referred to herein as a raster width. According to an embodiment, the raster width may be different in the two spatial directions. For example, according to an embodiment, the raster field may have a size of 50 mm×100 mm, i.e. according to an embodiment, the points of the representative pattern are determined within a 50 mmx 100 mm raster field. According to an embodiment, the value for the raster width lies in an interval between 1 mm and 500 mm. According to a further embodiment, the value for the raster width lies in an interval between 30 mm and 200 mm.

According to an embodiment, points of the representative pattern are determined for each raster field. For example, a representative pattern is determined for each raster field. Consequently, according to an embodiment, the representative pattern is a point set of which each point indicates a position of a pattern element of the first pattern in the raster field. For example, according to an embodiment, the representative pattern is a point set which consists of two points (or, in other embodiments, of three points or more than three points, for example, four points), wherein each of the points of the point set indicates a position of a pattern element of the first pattern in the raster field. According to an embodiment, a container (i.e., a predetermined point set) is determined in each raster field as the representative pattern.

It is pointed out that the rasterization described herein is not a rasterization in the usual sense. This is because, in an embodiment in which a container is scanned/determined in each raster step or raster field, each raster field does not define a single value which is associated with the raster field, but rather a predetermined point set is associated with each raster field according to the embodiments disclosed herein.

According to a further embodiment, the predetermined raster field is not defined by predetermined dimensions (for example, 100 mm×100 mm, as set forth above), but rather by a predetermined number of pattern elements. For example, the predetermined raster field may have by definition a size of 10×10 pattern elements or, according to another embodiment, a size of 10×5 pattern elements. According to a further embodiment, the representative pattern may be defined by the pattern elements at the corners of the raster field (for example at the four corners of a quadrangular raster field). Instead of a quadrangular raster field, it is also possible to use an polygonal raster field with n edges (wherein n is a natural number greater than or equal to 2, n≥2), for example a triangular raster field.

In order to keep a processing effort (computing effort) low, according to an embodiment the representative pattern is limited to a few pattern elements (respectively the points which represent the few pattern elements). For example, a rotation of the representative pattern relative to the ideal first pattern is already with two pattern elements/points detectable or, respectively, the corresponding mapping rule definable.

According to an embodiment, the determination of the representative pattern from the sensor data is performed by the control device. According to a further embodiment, the determination of the representative pattern is performed at least partially temporally in parallel to the provision of the sensor data. For example, the determination of the representative pattern may be performed based on an already determined part of the sensor data, while another part of the sensor data is still provided by the sensor device. This may also be referred to as parallel generation and processing of the sensor data. According to a further embodiment, first the (total) sensor data are provided and subsequently the representative pattern is determined. This may also be referred to as sequential generation and processing of the sensor data.

According to an embodiment, the point set of the representative pattern (e.g., a container), for which the mapping rule is defined, is determined within a predetermined raster field by the control device.

According to an embodiment, the size of the raster field (also referred to herein as a raster width) is given by 10 times the pitch distance of two adjacent pattern elements of the ideal first pattern or, according to another embodiment, by 5 times or 20 times the pitch distance. The term “pitch distance”, as used herein, defines a distance between two mutually corresponding parts of a pattern (e.g., of the first pattern or of the ideal first pattern). For example, the pitch distance of two pattern elements defines a distance between two mutually corresponding parts of the two pattern elements (for example, a distance of the centers (or the centers of gravity) of the two pattern elements).

According to an embodiment, the raster width is determined by the sensor device. For example, according to an embodiment, the sensor device may provide the sensor data in parts, wherein each part of the sensor data corresponds to a raster field. According to a further embodiment, the raster width is determined by the control device, i.e., the processing of the sensor data (by the control device) comprises the rasterization. For example, the processing of the sensor data is performed in parts, wherein each part corresponds to a raster field.

According to an embodiment, the raster width is selected such that the non-linear distortions of the first pattern are taken into account according to sampling theorem of Shannon and Nyquist. For example, according to an embodiment, the raster width is at least twice as large as the pitch distance of elements of the representative pattern.

According to a further embodiment, the sensor device is configured for sensing the first pattern such that the sensor data represent the first pattern in total. In this case, the determination of the representative pattern from the sensor data is performed only after the sensing. For example, the sensor data define a representation of the first pattern, for example an electronic representation. For example, according to an embodiment, the sensor data are image data which define an image of the first pattern.

According to a further embodiment, the representative pattern is determined from the sensor data, for example by the control device. In other words, according to an embodiment, the control device is configured for determining the representative pattern from the sensor data. For example, from the sensor data the coordinates of pattern elements of the first pattern are determined, for example at least (i.e. exclusively or inter alla) the coordinates of the pattern elements of the representative pattern. For example, according to an embodiment, all pattern elements of the first pattern are identified. According to an embodiment, subsequently, among the pattern elements of the first pattern those pattern elements which form the representative pattern are identified, for example according to a predetermined determination rule.

According to an embodiment, the representative pattern is a subset of the first pattern. For example, according to an embodiment, the first pattern comprises a plurality of pattern elements and the subset comprises only a part of the plurality of pattern elements. According to a further embodiment, adjacent pattern elements in the first pattern comprise a first pitch distance and adjacent pattern elements in the subset comprise a second pitch distance which is larger than the first pitch distance.

According to an embodiment, the predetermined determination rule defines that every fourth pattern element forms a pattern element of the representative pattern. The determination rule which identifies only a part of the pattern elements of the first pattern as pattern elements of the representative pattern consequently defines a raster operation at the pattern element level. Since, according to an embodiment, a predetermined number of pattern elements of the representative pattern define a container according to embodiments of the herein disclosed subject matter, it can consequently also be referred to a rasterization of the first pattern with a container (e.g., a container disclosed herein).

According to an embodiment, coordinates are determined only of those pattern elements which form the representative pattern. In this way, the determination of coordinates of pattern elements of the representative pattern can be performed very efficiently. According to an embodiment, coordinates of a pattern element are defined by coordinates of a point which represents the respective pattern element, for example, by coordinates of a center of gravity of the respective pattern element. According to an embodiment, the determination of the coordinates of the pattern elements of the representative pattern is performed on the basis of the sensor data (for example, by evaluating the sensor data, for example, by the control device).

In embodiments in which the representative pattern corresponds to only a part of the first pattern in the raster field, the representative pattern comprises a smaller information content than the first pattern in the raster field. Nevertheless, the representative pattern also in this case represents the first pattern of the workpiece (respectively the respective part of the first pattern). In this way, a memory requirement and a computing requirement for determining the mapping rule can be reduced.

According to an embodiment, the raster width is freely definable.

As explained above, the information content of the representative pattern can be reduced, for example, by sensing the first pattern with a predetermined raster width and/or by rasterizing the first pattern (for example, by rasterizing a representation of the first pattern).

The rasterization of the first pattern (for example, with a predetermined raster width or at pattern element level) can be performed on the basis of the first pattern on the workpiece or on the basis of a representation of the first pattern (for example, on the basis of a representation of the first pattern in the sensor data).

According to an embodiment, the first pattern extends over a first field and the representative pattern extends over a second field, which is part of the first field. For example, the sensor device may be configured (or controlled by the control device) for sensing the first pattern only in a part of the first pattern (i.e., in a part of the field over which the first pattern extends).

According to an embodiment, the representative pattern coincides with the first pattern in predetermined pattern elements, wherein, for example, the predetermined pattern elements may be spaced apart from each other. In other words, the part of the first pattern may be formed from a plurality of regions of the pattern located at a distance from each other. According to an embodiment, further pattern elements of the first pattern may be arranged between the predetermined pattern elements.

According to a further embodiment, the part of the first pattern may be a contiguous part of the first pattern.

According to an embodiment, the first pattern and the second pattern overlap on the workpiece. For example, according to an embodiment, elements of the first pattern may be arranged congruent with elements of the second pattern. According to a further embodiment, an element of the first pattern extends over a surface portion of the workpiece (i.e., over a field) and an element of the second pattern extends at least partially over the surface portion (or the field).

According to embodiments of the first aspect, the laser processing device is configured to provide the functionality of one or more of the herein disclosed embodiments and/or to provide the functionality as required for one or more of the herein disclosed embodiments, in particular the embodiments of the first aspect, the second aspect, the third aspect and/or the fourth aspect.

According to embodiments of the second aspect, the method is configured to provide the functionality of one or more of the herein disclosed embodiments and/or to provide the functionality as required for one or more of the herein disclosed embodiments, in particular the embodiments of the first aspect, the second aspect, the third aspect and/or the fourth aspect.

According to embodiments of the third aspect, the computer program product is configured to provide the functionality of one or more of the herein disclosed embodiments and/or to provide the functionality as required for one or more of the herein disclosed embodiments, in particular the embodiments of the first aspect, the second aspect, the third aspect and/or the fourth aspect.

According to embodiments of the fourth aspect, the workpiece is configured to provide the functionality of one or more of the herein disclosed embodiments and/or to provide the functionality as required for one or more of the herein disclosed embodiments or as resulting from one or more of the herein disclosed embodiments, in particular the embodiments of the first aspect, the second aspect, the third aspect and/or the fourth aspect.

According to an embodiment, the program element is a non-transient program element. According to a further embodiment, the computer program product is a non-transient computer program product.

As used herein, the reference to a computer program product comprising a program element is regarded as being equivalent to a reference to a computer program comprising a program element and/or a computer readable medium comprising a program element. According to an embodiment, the program element comprises instructions for controlling a processor device (with one or more microprocessors, for example a computer system), for effecting and/or coordinating the execution of at least one method described herein.

The (non-transient) program element can be implemented as computer readable instruction code using any suitable programming language, such as JAVA, C#, Python, etc., and can be stored on a computer readable medium (removable disk, volatile or non-volatile memory, embedded memory/processor, etc.). According to an embodiment, the instruction code is executable for programming a computer or any other programmable processor device to perform the intended functions. The computer program may be available on a network, for example the World Wide Web, from which it can be downloaded, for example.

Suitable embodiments of the herein disclosed subject matter (for example a functionality of the control device) can be realized by means of a computer program product (program element) or software, respectively. However, suitable embodiments can also be realized by one or more specific electronic circuits, or hardware, respectively. Furthermore, suitable embodiments can also be realized in hybrid form, i.e. in a combination of software modules and hardware modules.

In the following, exemplary embodiments of the herein disclosed subject matter are described, wherein, for example, reference is made to a method for processing a workpiece, a computer program product, a workpiece and a laser processing device. It should be emphasized that, of course, any combination of features of different aspects, embodiments and examples is possible. In particular, some embodiments are described with reference to a method, while other embodiments are described with reference to a device. Yet other embodiments are described with reference to a workpiece, while other embodiments are described with reference to a control device for interacting with further elements of the laser processing device. However, those skilled in the art will appreciate from the foregoing and following description, claims and drawings that, unless otherwise specified, features of different aspects, embodiments and examples are combinable and such combinations of features are to be considered as disclosed by this application. For example, even a feature which relates to a method is combinable with a feature which relates to a device, and vice versa.

According to an embodiment, a method disclosed herein can define the functionality of a device disclosed herein without being limited to the device-specific features. In this respect, any functionality disclosed herein of a device disclosed herein is intended to implicitly disclose a corresponding method which is defined exclusively by the disclosed functionality. Conversely, according to an embodiment, a method disclosed herein can be performed with any suitable known device (which may comprise a single element or a plurality of cooperating elements). In this respect, any method disclosed herein is intended to implicitly disclose a corresponding device which is configured to perform the method.

Other advantages and features of the present disclosure will become apparent from the following exemplary description of presently preferred embodiments, to which the claimed invention is not limited. The individual figures of the drawings of this document are to be regarded merely as schematic and not to scale.

### BRIEF DESCRIPTION OF THE DRAWINGS

FIG. 1 illustrates a laser processing according to embodiments of the herein disclosed subject matter.

FIG. 2 shows a laser processing device 150 according to embodiments of the herein disclosed subject matter.

### DETAILED DESCRIPTION

It is noted that in different figures, similar or identical elements or components are provided with the same reference numerals, or with reference numerals which differ only in the first digit or an appended letter. Such features or components, which are identical or at least functionally identical with the corresponding features or components in another figure, will only be described in detail in the following text upon their first occurrence and the description will not be repeated upon subsequent occurrence of these features and components (or the corresponding reference numerals).

It is understood that an exemplary implementation of the elements described below and provided with reference numerals is illustrated in the respective drawings and configured according to the following description, unless otherwise specified.

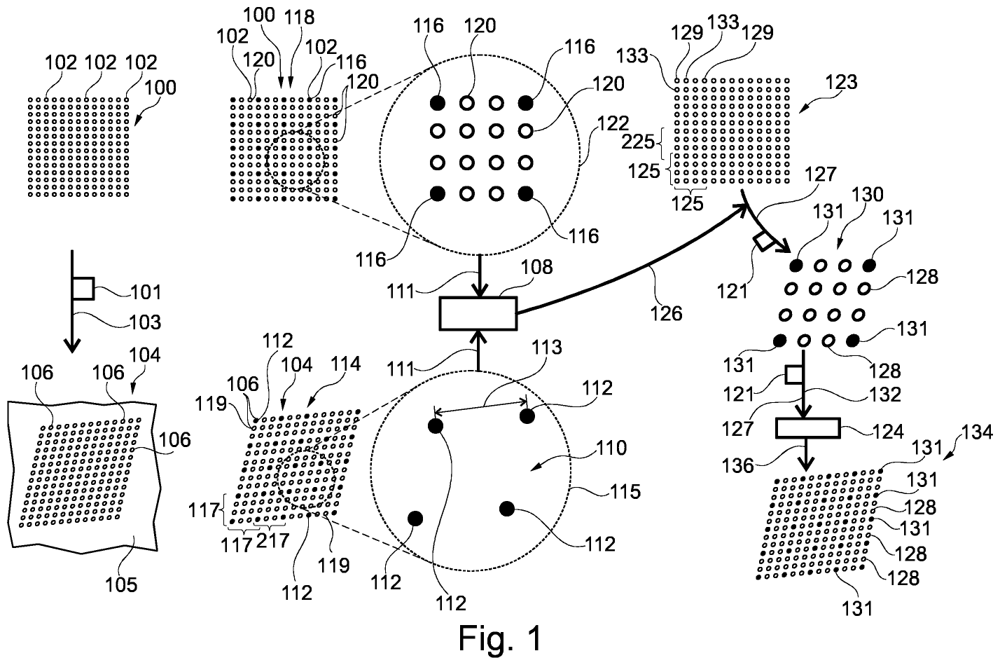

FIG. 1 illustrates a mode of operation of a laser processing device and a method according to embodiments of the herein disclosed subject matter.

According to an embodiment, a workpiece 105 comprises a first pattern 104. According to a further embodiment, with the first pattern 104 there is associated an ideal first pattern 100 which is defined by a first pattern definition 101. For example, according to an embodiment, the first pattern 104 has been generated on the basis of the first pattern definition 101. The generation of the first pattern 104 on the basis of the first pattern definition 101 is indicated schematically at 103 in FIG. 1.

According to an embodiment, the ideal first pattern 100 comprises a plurality of pattern elements 102, for example circular pattern elements, which are arranged in rows and columns, for example as illustrated in FIG. 1. According to an embodiment, the pattern elements are arranged with a constant pitch distance (equidistantly), for example as illustrated in FIG. 1. For reasons of clarity, only some of the pattern elements of the ideal first pattern 100 are marked with the reference numerals 102.

According to an embodiment, the pattern elements 102 of the ideal first pattern 100 correspond to corresponding pattern elements 106 of the first pattern 104 on the workpiece 105. According to an embodiment, the pattern elements 106 are recesses in the workpiece 105. For example, according to an embodiment, the workpiece 105 comprises a substrate and a coating, wherein the coating is removed in the region of the pattern elements 106 and thus forms the pattern elements 102. According to an embodiment, the substrate is a plate-shaped substrate (for example a flat substrate). According to an embodiment, the workpiece 105 is a solar module.

According to an embodiment, the pattern elements 102 of the ideal first pattern 100 are circular markings, which correspond, for example, to circular (i.e., circularly round) pattern elements 106 in the form of circularly round holes on the workpiece 105, which are arranged, for example, in rows and columns with a certain pitch distance of, for example, 1 mm.

According to an embodiment, the first pattern 104 differs from the ideal first pattern 100, for example due to manufacturing tolerances (machine errors) and/or temperature changes (change in temperature compared to the manufacturing conditions under which the first pattern was generated). For example, the first pattern 104 can be distorted and twisted compared to the ideal first pattern 100, for example as illustrated in FIG. 1. According to an embodiment, the first pattern 104 was generated on the basis of the ideal first pattern 100 by a suitable processing device (for example a laser device), for which the pattern definition 101 of the ideal first pattern 100 serves as input data.

According to an embodiment, a mapping rule is determined, illustrated schematically at 108 in FIG. 1, which defines a mapping from the ideal first pattern 100 to a representative pattern 110, wherein the representative pattern 110 corresponds to at least a part of the first pattern 104. The determination of the mapping rule 108 based on the ideal first pattern 100 (or a part thereof) and the representative pattern 110 is indicated at 111 in FIG. 1. According to an embodiment, the representative pattern 110 coincides with the first pattern 104 in predetermined portions (or pattern elements) 112. For example, the first pattern 104 may comprise at least two pattern elements 106 (for example a plurality of pattern elements 106), a part of which defines the representative pattern 110. For example, it may be provided that each fourth pattern element 106 of the first pattern 104 coincides with the representative pattern 110, for example as illustrated in a representation 114 of the first pattern 104 in FIG. 1. In this representation 114, for better distinguishability, predetermined pattern elements 106 which are contained in the representative pattern 110 are represented by full circles and partially also denoted by reference numerals 112, while the remaining pattern elements 106 which are not contained in the representative pattern 110 and partially denoted by the reference numeral 119 are represented by empty circles. According to an embodiment, the representative pattern 110 therefore comprises only a part of the first pattern 104, for example as illustrated at 112 in FIG. 1. According to an embodiment, the representative pattern 110 represents only a part of the first pattern, for example 4×4 pattern elements 106, 112 of the first pattern, for example as illustrated in the enlarged view 115 in FIG. 1. The 4×4 pattern elements consequently define a raster field 117, 217 as described herein. According to an embodiment, pattern elements may be associated with two raster fields 117, 217, for example as illustrated in FIG. 1. According to another embodiment (not illustrated), each pattern element 106 is associated with only a single raster field. Furthermore, the representative pattern 110 comprises only predetermined pattern elements 112 (for example every fourth pattern element 106 of the raster field 117, 217), but not the pattern elements 119 (or pattern portions) which lie between the predetermined pattern elements 112 of the first pattern 104. In other words, according to an embodiment, the representative pattern 110 is defined exclusively by the (predetermined) pattern elements 112 of the first pattern 104. A pitch distance 113 of the pattern elements 112 (for example, the distance of the centers or the centers of gravity of the pattern elements 112) corresponds in an embodiment to the raster width to which reference is made in embodiments of the herein disclosed subject matter. According to an embodiment, the pattern elements 112 correspond to the pattern elements of the representative pattern 110. The pattern elements 112 of the representative pattern 110 in FIG. 1 define a container according to embodiments of the herein disclosed subject matter.

According to an embodiment, the representative pattern 110 extends only over a part of the field over which the first pattern 104 extends. According to an embodiment, the first pattern is formed by groups of pattern elements which repeat in the first pattern. In such a case, according to an embodiment, the representative pattern 110 extends only over a single group of pattern elements, for example as illustrated in the enlarged view 115 in FIG. 1. According to an embodiment, a container is based on one of the groups of pattern elements and is defined by a predetermined number (for example, a minimum number) of pattern elements 112 which delimit the group of pattern elements. Generally, according to an embodiment, a container is defined by a predetermined (e.g., minimum) number of pattern elements which span a two-dimensional area (for example, a predetermined two-dimensional area, for example, a quadrangle). For example, the group of pattern elements is arranged in rows and columns and the representative pattern 110 comprises four pattern elements 112 which form the corners of the group of pattern elements. According to an embodiment, the entire field of the first pattern is coverable with the group of pattern elements by repetition, for example as illustrated in the illustration 114 in FIG. 1. According to an embodiment, a group of pattern elements 106 is just defined by the pattern elements 112 which form the representative pattern 110. For example, a group of pattern elements 106 has a quadrangular shape, wherein the pattern elements in the four corners (represented by full circles in the illustration 114) form the representative pattern 110. According to an embodiment, adjacent groups of pattern elements comprise common pattern elements, for example as illustrated in FIG. 1. In this way, a uniform distribution of the pattern elements 112, which form the representative pattern, is achieved, for example as illustrated in FIG. 1.

According to an embodiment, the pattern elements 112 of the representative pattern 110 are described by the spatial coordinates thereof. According to an embodiment, the position of the pattern elements 112 of the representative pattern 110 and the position of corresponding pattern elements 116 of the ideal pattern 100 are only in a plane (i.e., in two dimensions) determined and used for determining the mapping rule 108, for example as illustrated in FIG. 1. For example, according to an embodiment, the mapping rule 108 is determined on the basis of Cartesian coordinates (X, Y) of the centers of gravity of the pattern elements 112 of the representative pattern 110 and of the centers of gravity of the pattern elements 116 of the ideal pattern 100.

It is understood that the ideal first pattern 100 may be arbitrarily designed and is not limited to a pattern comprising a plurality of individual pattern elements 102 arranged at a distance from each other. For example, the ideal first pattern 100 may comprise contiguous pattern elements (not illustrated in FIG. 1) (for example line sections which form a single line). Likewise, pattern elements 102 of the ideal first pattern 100 may be arbitrarily designed. It is understood that the above explanations and embodiments also apply analogously to the first pattern 104 and the pattern elements 106 thereof.

According to an embodiment, the mapping rule 108 defines a mapping of the ideal first pattern 100 to the representative pattern 110. For example, pattern elements 116 of the ideal first pattern 100 which correspond to the predetermined pattern elements 112 of the first pattern 104 which are contained in the representative pattern 110 form the starting point for the mapping rule 108. In other words, according to an embodiment, the mapping rule 108 does not map the entire ideal first pattern 100 to the representative pattern 110, but rather only the part (for example the pattern elements 116) of the ideal first pattern 100 which corresponds to the representative pattern 110, for example as illustrated in FIG. 1. Furthermore, in accordance with an embodiment, the mapping rule 108 does not define a mapping of a single point (or a single pattern element 116) of the ideal first pattern 100 to a corresponding single point (or single pattern element 112) of the representative pattern 110, but rather a mapping of a point set (for example a set of pattern elements 116) of the ideal first pattern 100 to a corresponding point set (for example a corresponding set of pattern elements 112) of the representative pattern 110.

In FIG. 1, in a representation 118 of the ideal first pattern 100, the pattern elements 116 of the ideal first pattern 100 (i.e. the portions of the ideal first pattern which correspond to the representative pattern) are represented by full circles, while the remaining pattern elements 120 of the ideal first pattern 100 are represented by empty circles. In FIG. 1, the enlarged view 122 of the ideal first pattern 100 shows both types of pattern elements 116, 120 of the ideal first pattern 100. The enlarged view 122 shows a group of pattern elements of the ideal first pattern 100 which corresponds to a group of pattern elements of the first pattern 104 on the basis of which the representative pattern 110 (pattern elements 112 in the enlarged view 115 in FIG. 1) has been determined.

According to an embodiment, the mapping rule 108 is applied to an ideal second pattern 123 to thereby generate processing data 124 that represents a second pattern 134 to be generated. The generation of the processing data 124 on the basis of the ideal second pattern 123 is symbolized by arrows 127 in FIG. 1. The use of the mapping rule 108 for generating the processing data 124 is indicated at 126 in FIG. 1.

According to an embodiment, as described above, it may be provided that the representative pattern 110 covers only a part of the first pattern 104 and thus only a part of the surface of the workpiece 105 so that, according to an embodiment, the mapping rule 108 directly captures only a part of the first pattern 104 (or a part of the surface of the workpiece 105 that comprises the first pattern 104). In this case, according to an embodiment, the mapping rule 108 may be defined exclusively for the pattern elements 112 of the representative pattern 110. For pattern elements 129 of the ideal second pattern 123 which are located at the same position as pattern elements 116 of the ideal first pattern (i.e. the pattern elements 116 which correspond to the pattern elements 112 of the representative pattern 110), the mapping rule 108 is readily applicable (in particular without interpolation). Consequently, the mapping rule 108 directly provides for these pattern elements 129 corresponding pattern elements 131 of the second pattern 134 to be generated.

According to a further embodiment, the generation of the processing data 124 comprises an interpolation of the mapping rule 108 to parts of the ideal second pattern 123 for which the mapping rule is not directly defined.

By the interpolation, pattern elements 133 of the ideal second pattern 123 for which the mapping rule 108 is not defined may be mapped for generating corresponding pattern elements 128 of the pattern 134 to be generated. The interpolation may be, for example, a bilinear interpolation (for example an interpolation in the X-direction and the Y-direction). According to an embodiment, interpolation is performed within the representative pattern (for example within the container (defined above)), i.e. within the pattern elements 112. In other words, according to an embodiment, for parts (pattern elements 133) of the ideal second pattern 123, the position of corresponding parts (pattern elements 128) of the second pattern 134 to be generated (for example within the container) is calculated via an interpolation. According to a further embodiment, an interpolation is carried out beyond the container.

According to a further embodiment, the mapping rule 108 is defined by a function that provides for arbitrary points or pattern elements 129, 133 of the ideal second pattern 123 corresponding points or pattern elements 128, 131 of the second pattern 134 to be generated. According to a further embodiment, the function is applied only to predetermined points or pattern elements (for example the points/pattern elements of the ideal second pattern which correspond to the position of the representative pattern or, respectively, the container) and other points/pattern elements (for example the points/pattern elements at a position which correspond to a position within the representative pattern or within the container) are interpolated.

According to a further embodiment, the ideal second pattern 123 is formed by a group 125 of pattern elements (for example a group 125 of 4×4 pattern elements, for example as illustrated in FIG. 1) which repeats in the ideal second pattern 123 (for example as indicated at 225). According to an embodiment, the generation of the processing data 124 comprises a generation of processing data for a single group 125 of pattern elements 129, 133 of the ideal second pattern 123, whereby a processing data part 121 is obtained for a corresponding group (illustrated schematically at 130) of the pattern 134 to be generated. According to a further embodiment, the generation of the processing data 124 comprises a repetition of the processing data part 121 for each of the groups 125, 225 in the ideal second pattern 123.

The repetition of the processing data part 121 for each of the groups 125, 225 of pattern elements is illustrated schematically at 132 in FIG. 1. As a result, the processing data 124 is obtained which represents a to be generated second pattern 134 which is correctly arranged with respect to the first pattern 104. According to an embodiment, “correctly arranged” means that a spatial relationship between the first pattern 104 and the to be generated second pattern 134 corresponds in this context to the spatial relationship between the ideal first pattern 100 and the ideal second pattern 123. For example, according to an embodiment, the ideal second pattern 123 is congruent with the ideal first pattern 100. By using a mapping rule 108 according to embodiments of the herein disclosed subject matter, in such a case, even in the case of a distortion of the first pattern 104, the to be generated second pattern 134 may be arranged congruent with the first pattern 104. The arrow at 136 in FIG. 1 indicates that the processing data 124 represents the to be generated second pattern 134.

According to an embodiment, the workpiece 105 thus comprises the first pattern 104 and furthermore, after the generation of the second pattern 134 is completed, also comprises the second pattern 134. According to an embodiment, the workpiece is consequently processed according to a method according to at least one embodiment of the herein disclosed subject matter.

Consequently, when the workpiece 105 is provided both with the first pattern 104 and with the second pattern 134, the workpiece comprises two patterns that are both transformed according to the same mapping rule 108. According to an embodiment, the first pattern 104 and the second pattern 134 are generated in different processing steps, for example as explained above.

According to an embodiment, adjacent groups 125, 225 of pattern elements 129, 133 of the ideal second pattern 123 comprise common pattern elements 129, 133, for example as illustrated in FIG. 1. According to another embodiment, the pattern elements 129, 133 of adjacent groups 125, 225 are arranged next to one another (not illustrated in FIG. 1).

It is understood that, in any case in an embodiment, the full circles 112, 116, 131 and the empty circles 119, 120, 128 merely serve for easier identifiability of the respective points or pattern elements in the explanation of embodiments and the respective pattern elements 112, 116, 119, 120, 128, 131 can actually be identical in their realization, however.

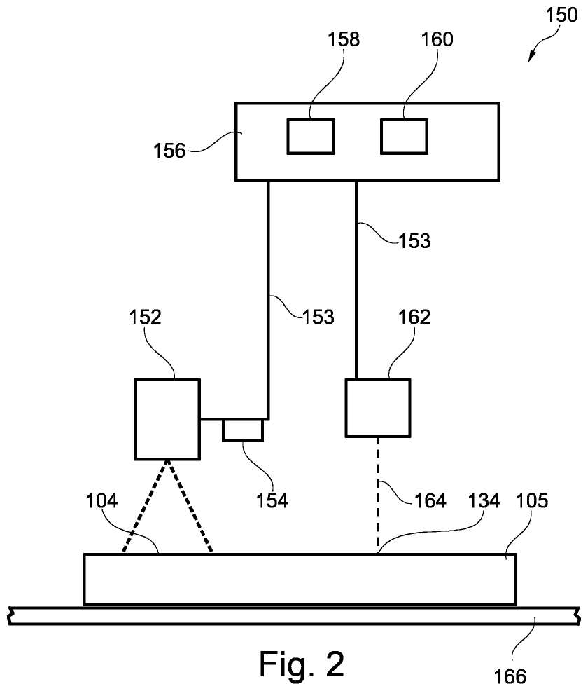

FIG. 2 shows a laser processing device 150 according to embodiments of the herein disclosed subject matter.

According to an embodiment, the laser processing device 150 is configured to realize the embodiments of the present disclosure described with reference to FIG. 1. Reference numerals which are mentioned in the description of FIG. 2 but are not contained in FIG. 2 therefore always refer to FIG. 1, unless otherwise expressly specified.

According to an embodiment, the laser processing device 150 comprises a sensor device 152 which is configured for sensing the first pattern 104 on the workpiece 105. The sensor device 152 is further configured for, upon the sensing of the first pattern 104, providing sensor data 154 from which the representative pattern 110 is determinable. The representative pattern 110 being determinable from the sensor data 154 also comprises an embodiment in which the representative pattern 110 is directly defined by the sensor data 154.

According to an embodiment, the laser processing device 150 comprises a control device 156. According to an embodiment, the sensor device 152 is connected to the control device 156 in a signal-transmitting manner, indicated at 153 in FIG. 2, for providing the sensor data 154 to the control device 156.

According to an embodiment, the control device 156 is configured for determining the representative pattern 110 from the sensor data 152.

According to an embodiment, the control device 156 comprises a data memory 158 and a processor device 160. According to an embodiment, the data memory 158 comprises a program element as described herein. In particular, according to an embodiment, the program element is configured for, when executed on the processor device 160, performing a method according to at least one embodiment of the herein disclosed subject matter. For example, according to an embodiment, the functionality of the control device 156 is at least partially defined by the program element.

According to an embodiment, the first pattern definition 101 is stored in the data memory 158 of the control device 156. Furthermore, according to an embodiment, the control device 156 is configured for determining the mapping rule 108. Furthermore, according to an embodiment, the control device 156 is configured for applying the mapping rule 108 to the ideal second pattern 123 to thereby generate the processing data 124, for example as described with reference to FIG. 1. According to an embodiment, the laser processing device 150 further comprises a laser device 162, wherein the control device 156 is configured according to an embodiment for controlling the laser device 162 and thereby processing the workpiece 105 with laser radiation 164 according to the processing data 124 and thereby generating the second pattern 134 or providing the workpiece 105 with the second pattern 134, respectively.

According to an embodiment, the control device 156 is connected to the laser device 162 in a signal-transmitting manner, for example as illustrated at 153 in FIG. 2, for example for transmitting the processing data 124 to the laser device 162 or for controlling the laser device 162 according to the processing data 124, to name just a few examples.

According to an embodiment, the laser device 162 comprises a 1D scanner (for example, a scanner with a plurality of mirrors on a rotating drum for moving the laser radiation 164 in one dimension over the workpiece) or a 2D scanner (for example, a galvanometer scanner with two movable mirrors for directing the laser radiation 164 to a two-dimensional field on the workpiece 105). It is understood that the laser processing device 150 may comprise a transport device 166 for moving the workpiece 105 and the laser device 162 relative to each other. Thereby, for example, an area of the workpiece 105 may be processed which is larger than the scanning area of the scanner (1D scanner or 2D scanner).

It is understood that a control device or a computer program product according to embodiments of the herein disclosed subject matter can always handle only data, i.e. a machine-processable representation of a pattern. Nevertheless, in the present disclosure, for simplifying the description, reference has often been made to the pattern itself (for example, the representing pattern, the ideal second pattern, etc.). In such a case, however, a person skilled in the art will read along, if necessary, a use of a suitable representation (for example, a pattern definition which defines the representing pattern, a second pattern definition which defines the second ideal pattern, etc.). Furthermore, according to an embodiment the present disclosure may be interpreted in such a way that a pattern always implicitly discloses also a corresponding pattern definition (or its use).

It should be noted that a laser processing device as described herein (or parts of the laser processing device, for example, the control device) is not limited to the dedicated entities as described in some embodiments. Rather, the herein disclosed subject matter can be implemented in numerous ways while still providing the disclosed specific functionality.

According to embodiments of the herein disclosed subject matter, any suitable entity (e.g., components, units and devices) can be provided at least partially in the form of corresponding computer programs which enable a processor device to provide the functionality of the corresponding entity as described herein. According to other embodiments, any suitable entity as described herein can be provided in hardware. According to other, hybrid embodiments, some entities can be provided in software while other entities are provided in hardware.

It is pointed out that any entity disclosed herein (e.g., components, units and devices) is not limited to a dedicated entity as described in some embodiments. Rather, the herein described subject matter can be provided in different ways with different granularity at device level or at software module level while still providing the specified functionality. For example, the control device described herein can be formed by two or more control units and the data memory can be formed by two or more memory units. For example, the program element can be stored in a first memory unit and a first pattern definition can be stored in a second memory unit. Furthermore, it should be noted that according to embodiments, a separate entity (e.g., a software module, a hardware module or a hybrid module) can be provided for each of the functions disclosed herein. According to other embodiments, an entity (e.g., a software module, a hardware module or a hybrid module) can be configured to provide two or more functions as described herein. According to still other embodiments, two or more entities (e.g., components, units and devices) can be configured to provide together a function as described herein.

A reference to a laser radiation can of course also be defined analogously with reference to a radiation path of the laser radiation, and vice versa. In this respect, any reference to a laser radiation discloses analogously a reference to a radiation path of the laser radiation herein.

It is pointed out that the embodiments described herein represent only a limited selection of possible embodiments of the present disclosure. Thus, it is possible to suitably combine the features of different embodiments with one another such that for a person skilled in the art with the herein explicitly disclosed embodiments a plurality of combinations of different embodiments are to be considered as disclosed. Furthermore, it should be mentioned that terms such as “a” or “an” do not exclude a plurality. Terms such as “containing” or “comprising” do not exclude further features or method steps. Consequently, according to an embodiment, the term “comprising” or “including” stands for “inter alia comprising”. According to a further embodiment, the term “comprising” or “including” stands for “consisting of”. According to an embodiment, the term “adapted to” comprises inter alia the meaning “configured to”.

The term “in particular” generally denotes optional features herein.

The term “A and/or B” always includes, in the usual manner, “only A”, “only B” and also “A and B”. In an expression that refers to a list of features, “at least one” always includes the individual features as well as any combinations of the features. For example, the expression “at least one of features A and B” includes the feature “only A”, “only B” and “A and B”. Similarly, the phrase “at least one of characteristics A or B” includes the characteristic “only A”, “only B” and “A and B”. Similarly, the phrase “at least one of characteristics A, B” includes the characteristic “only A”, “only B” and “A and B”.

It should also be noted that reference signs in the claims should not be interpreted as limiting the scope of the claims. Furthermore, it should be noted that reference signs in the description and the reference of the description to the drawings should not be interpreted as limiting the scope of the description. Rather, the drawings illustrate only an exemplary implementation of a particular combination of a plurality of embodiments of the herein disclosed subject matter, wherein any other combination of embodiments is equally possible and is to be considered as disclosed with this application.

In summary, it remains to be stated:

There is disclosed a laser processing device and a method for processing a workpiece 105 that is provided with a first pattern 104, the method comprising: sensing the first pattern 104 and providing hereupon sensor data 154 from which a representative pattern 110 is determinable that represents at least a part of the first pattern 104 of the workpiece 105; determining a mapping rule 108 that defines a mapping from an ideal first pattern to the representative pattern 110, wherein the ideal first pattern is associated with the first pattern 104 of the workpiece 105; applying the mapping rule 108 to an ideal second pattern 123 to thereby generate processing data 124 that represents a second pattern 134 to be generated; processing the workpiece 105 according to the processing data 124.

1-10. (canceled)

11. Laser processing device for processing a workpiece that is provided with a first pattern, the laser processing device comprising:
a sensor device;
a control device; and
a laser device;
wherein the sensor device is configured for sensing the first pattern and for providing hereupon sensor data from which a representative pattern is determinable that represents at least a part of the first pattern of the workpiece;
wherein an ideal first pattern is associated with the first pattern of the workpiece;
wherein the control device is configured for determining a mapping rule that defines a mapping of the ideal first pattern to the representative pattern;
wherein the control device is configured for applying the mapping rule to an ideal second pattern to thereby generate processing data that represents a second pattern to be generated;
wherein the control device is configured for controlling the laser device and thereby processing the workpiece according to the processing data.

12. The laser processing device according to claim 11, wherein the control device is configured for taking into account at least one of the following in the determination of the mapping rule:
a linear displacement between the first pattern and the ideal first pattern;
a distortion of the first pattern with respect to the ideal first pattern;
a rotation of the first pattern with respect to the ideal first pattern.

13. The laser processing device according to claim 12, wherein the distortion of the first pattern with respect to the ideal first pattern comprises at least one of the following:
a stretching or compression of the first pattern with respect to the ideal first pattern in at least one direction;
a shearing of the first pattern with respect to the ideal first pattern.

14. The laser processing device according to claim 11, wherein the control device is configured for determining the representative pattern from the sensor data.

15. The laser processing device according to claim 11,
wherein the representative pattern is a subset of the first pattern.

16. The laser processing device according to claim 15,
wherein the first pattern comprises a plurality of pattern elements and wherein the subset comprises only a part of the plurality of pattern elements.

17. The laser processing device according to claim 11, wherein the representative pattern coincides with the first pattern in predetermined pattern elements.

18. The laser processing device according to claim 17, wherein the predetermined pattern elements are spaced apart from each other.

19. The laser processing device according to claim 11, wherein the first pattern and the second pattern overlap on the workpiece.

20. Method for processing a workpiece that is provided with a first pattern, the method comprising:
sensing the first pattern and providing hereupon sensor data from which a representative pattern is determinable that represents at least a part of the first pattern of the workpiece;
determining a mapping rule that defines a mapping of an ideal first pattern to the representative pattern, wherein the ideal first pattern is associated with the first pattern of the workpiece;
applying the mapping rule to an ideal second pattern to thereby generate processing data that represents a second pattern to be generated;
processing the workpiece according to the processing data.

21. The method according to claim 20, further comprising taking into account at least one of the following in the determination of the mapping rule:
a linear displacement between the first pattern and the ideal first pattern;
a distortion of the first pattern with respect to the ideal first pattern;
a rotation of the first pattern with respect to the ideal first pattern.

22. The method according to claim 21, wherein the distortion of the first pattern with respect to the ideal first pattern comprises at least one of the following:
a stretching or compression of the first pattern with respect to the ideal first pattern in at least one direction;
a shearing of the first pattern with respect to the ideal first pattern.

23. The method according to claim 20, further comprising determining the representative pattern from the sensor data.

24. The method according to claim 20,
wherein the representative pattern is a subset of the first pattern.

25. The method according to claim 24, wherein the first pattern comprises a plurality of pattern elements and wherein the subset comprises only a part of the plurality of pattern elements.

26. The method according to claim 20, wherein the representative pattern coincides with the first pattern in predetermined pattern elements.

27. The method according to claim 26, wherein the predetermined pattern elements are spaced apart from each other.

28. The method according to claim 11, wherein the first pattern and the second pattern overlap on the workpiece.

29. Computer program product that is configured for, when executed on a processor device, controlling a method according to claim 20.

30. Workpiece comprising
a first pattern that is, compared to an ideal first pattern, transformed according to a mapping rule;
a second pattern that is, compared to an ideal second pattern, transformed according to the mapping rule,
wherein the first pattern and the second pattern were generated in different process steps.
